(19) United States
(12) Patent Application Publication
(10) Pub. No.: US 2023/0151927 A1
(43) Pub. Date: May 18, 2023

(54) HIGH-PRESSURE TANK AND METHOD FOR MANUFACTURING HIGH-PRESSURE TANK

(71) Applicant: TOYOTA JIDOSHA KABUSHIKI KAISHA, Toyota-shi (JP)

(72) Inventors: Koji KATANO, Toyota-shi (JP); Takashi USUI, Toyota-shi (JP)

(73) Assignee: TOYOTA JIDOSHA KABUSHIKI KAISHA, Toyota-shi (JP)

(21) Appl. No.: 18/150,981

(22) Filed: Jan. 6, 2023

Related U.S. Application Data
(62) Division of application No. 17/337,543, filed on Jun. 3, 2021.

(30) Foreign Application Priority Data
Jul. 31, 2020 (JP) 2020-130016

(51) Int. Cl. F17C 1/06

(52) U.S. Cl. CPC F17C 1/06; F17C 2203/012; F17C 2203/0604; F17C 2201/0114; F17C 2270/0184; F17C 2209/2163; F17C 2209/232; F17C 2221/012; F17C 2203/0673

(57) ABSTRACT

A high-pressure tank includes a reinforcing layer and a liner having a gas-barrier property and disposed on an inner surface of the reinforcing layer. The reinforcing layer includes a cylindrical reinforcing pipe having a plurality of cylindrical pipe forming portions coupled together, and a pair of semispherical reinforcing domes, one of the pair of semispherical reinforcing domes being disposed at a first end of the reinforcing pipe, and the other one of the pair of semispherical reinforcing domes being disposed at a second end of the reinforcing pipe.

### CROSS-REFERENCE TO RELATED APPLICATION

This application claims priority to Japanese Patent Application No. 2020-130016 filed on Jul. 31, 2020, incorporated herein by reference in its entirety.

### BACKGROUND

### 1. Technical Field

The present disclosure relates to a high-pressure tank and a method for manufacturing the high-pressure tank.

### 2. Description of Related Art

There is known a technology related to a tank that stores fuel gas. In this technology, a tubular molded portion is formed by winding a sheet-shaped fiber-reinforced resin layer, and a tank body is formed by arranging the formed tubular molded portion around the peripheral surface of a liner (for example, Japanese Unexamined Patent Application Publication No. 2017-94491 (JP 2017-94491 A)).

### SUMMARY

Required dimensions of tanks that store gas may vary depending on, for example, purposes of use and installation places of the tanks. To manufacture tanks having different dimensions in the related art, a plurality of manufacturing lines is necessary to form bodies having different dimensions. Therefore, there is a demand for a technology capable of changing the dimensions of tanks by a simple method.

The present disclosure provides a high-pressure tank and a method for manufacturing the high-pressure tank.

A first aspect of the present disclosure relates to a high-pressure tank. The high-pressure tank includes a reinforcing layer and a liner having a gas-barrier property and disposed on an inner surface of the reinforcing layer. The reinforcing layer includes a cylindrical reinforcing pipe having a plurality of cylindrical pipe forming portions coupled together, and a pair of semispherical reinforcing domes, one of the pair of semispherical reinforcing domes being disposed at a first end of the reinforcing pipe, and the other one of the pair of semispherical reinforcing domes being disposed at a second end of the reinforcing pipe.

According to the first aspect, the reinforcing layer includes the cylindrical reinforcing pipe having the cylindrical pipe forming portions coupled together. The dimension of the reinforcing pipe can arbitrarily be adjusted by combining and joining an arbitrary number of pipe forming portions having arbitrary lengths. Thus, the dimension of the high-pressure tank can be changed by a simple method.

In the first aspect, the high-pressure tank may further include a junction arranged in a recess provided between the adjacent pipe forming portions abutting against or approaching each other, the junction joining the adjacent pipe forming portions.

According to the structure described above, a decrease in the joining strength of the reinforcing pipe can be suppressed or prevented by joining the pipe forming portions by the junction at the joining position where the strength is likely to decrease.

In the aspect described above, an outer diameter of the junction may be larger than an outer diameter of the reinforcing pipe. According to the structure described above, a decrease in the strength at the joining position of the pipe forming portions can be suppressed or prevented more securely by arranging the junction to cover the outer surfaces at the joining position of the pipe forming portions where the strength is likely to decrease.

In the aspect described above, an inner diameter of the junction may be smaller than an inner diameter of the reinforcing pipe. According to the structure described above, the decrease in the strength at the joining position of the pipe forming portions can be suppressed or prevented more securely by arranging the thick junction at the joining position of the pipe forming portions where the strength is likely to decrease.

In the aspect described above, a material for the junction may contain a reinforcing fiber and a thermoplastic resin. According to the structure described above, the pipe forming portions can easily be joined by thermocompression bonding. By containing the fiber bundle, the strength at the joining position of the pipe forming portions can be improved.

In the first aspect, at least one pipe forming portion out of the pipe forming portions may include, at an axial end of the one pipe forming portion, a fitting portion having a shape in which the fitting portion protrudes toward another pipe forming portion adjacent to the at least one pipe forming portion. The other pipe forming portion adjacent to the at least one pipe forming portion may include, at an axial end of the other pipe forming portion, a fitted portion having a recessed shape conforming to the shape of the fitting portion.

According to the structure described above, axial displacement is reduced or prevented at the joining position while improving the joining strength of the pipe forming portions. Thus, variation in the axial dimension of the reinforcing pipe can be reduced.

In the aspect described above, the junction may protrude from an outer surface of the reinforcing pipe toward an outer side of the reinforcing pipe.

In the aspect described above, the junction may protrude from art inner surface of the reinforcing pipe toward an axis center of the reinforcing pipe.

In the aspect described above, at least one pipe forming portion out of the pipe forming portions may have a first abutment surface at art axial end of the one pipe forming portion. Another pipe forming portion adjacent to the at least one pipe forming portion may have a second abutment surface. The first abutment surface and the second abutment surface may abut against each other.

A second aspect of the present disclosure relates to a method for manufacturing a high-pressure tank. The method includes causing adjacent cylindrical pipe forming portions to abut against each other, arranging a junction made of a material containing a reinforcing fiber and a thermoplastic resin on an outer surface at an abutment position of the adjacent pipe forming portions, forming a cylindrical reinforcing pipe by heating and thermocompressively bonding the junction to join the pipe forming portions, and forming a liner made of a resin and having a gas-barrier property on an inner surface of the formed reinforcing pipe.

According to the second aspect, the liner is formed after joining the pipe forming portions. Thus, it is possible to reduce or prevent such a trouble that the liner enters the abutment position of the pipe forming portions when the high-pressure tank is charged with gas.

A third aspect of the present disclosure relates to a method for manufacturing a high-pressure tank. The method includes preparing a plurality of cylindrical pipe forming portions, forming, at an end of at least one pipe forming portion out of the pipe forming portions, a fitting portion having a shape in which the fitting portion protrudes toward another pipe forming portion adjacent to the at least one pipe forming portion, forming, at an end of the other pipe forming portion adjacent to the at least one pipe forming portion, a fitted portion having a recessed shape conforming to the shape of the fitting portion, forming liners each made of a resin and having a gas-barrier property on inner surfaces of the pipe forming portions, and forming a cylindrical reinforcing pipe by heating and thermocompressively bonding the liners on the pipe forming portions having the fitting portion and the fitted portion fitted together to join the pipe forming portions.

According to the third aspect, at least one pipe forming portion and other pipe forming portion adjacent to the at least one pipe forming portion can be joined without using an adhesive or junction, and therefore the number of components can be reduced.

The present disclosure may be implemented in various forms other than the high-pressure tank and the method for manufacturing the high-pressure tank. For example, the present disclosure may be implemented in various forms such as a reinforcing pipe, a method for manufacturing the reinforcing pipe, and an apparatus for manufacturing the high-pressure tank.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view illustrating the structure of a high-pressure tank of a first embodiment;

FIG. 2 is an explanatory drawing schematically illustrating the structure of pipe forming portions;

FIG. 3 is a process drawing illustrating a method for manufacturing the high-pressure tank;

FIG. 4 is a process drawing illustrating a method for manufacturing a reinforcing pipe;

FIG. 5 is an explanatory drawing illustrating an example of a method for forming the pipe forming portions;

FIG. 6 is an explanatory drawing schematically illustrating a method for joining a first pipe forming portion and a second pipe forming portion;

FIG. 7 is an explanatory drawing illustrating an example of a method for forming reinforcing domes;

FIG. 8 is an explanatory drawing illustrating a method for forming an outer helical layer;

FIG. 9 is an explanatory drawing schematically illustrating the structure of pipe forming portions as Other Aspect 1 of the first embodiment;

FIG. 10 is an explanatory drawing schematically illustrating a method for joining the pipe forming portions as Other Aspect 1 of the first embodiment;

FIG. 11 is an explanatory drawing schematically illustrating the structure of pipe forming portions as Other Aspect 2 of the first embodiment;

FIG. 12 is an explanatory drawing schematically illustrating a method for joining the pipe forming portions as Other Aspect 2 of the first embodiment;

FIG. 13 is an explanatory drawing schematically illustrating the structure of pipe forming portions according to a second embodiment;

FIG. 14 is a process drawing illustrating a method for manufacturing a reinforcing pipe according to the second embodiment;

FIG. 15 is an explanatory drawing schematically illustrating the structure of pipe forming portions as another aspect of the second embodiment;

FIG. 16 is an explanatory drawing illustrating the end of a first pipe forming portion and the end of a second pipe forming portion;

FIG. 17 is an explanatory drawing schematically illustrating the structure of pipe forming portions according to a third embodiment;

FIG. 18 is a process drawing illustrating a method for manufacturing a high-pressure tank of the third embodiment;

FIG. 19 is a process drawing illustrating a step of forming a reinforcing pipe;

FIG. 20 is an explanatory drawing illustrating a first pipe forming portion and a second pipe forming portion;

FIG. 21 is an explanatory drawing illustrating the first pipe forming portion and the second pipe forming portion on which liners are formed;

FIG. 22 is an explanatory drawing illustrating a method for joining the reinforcing pipe to a reinforcing dome having a dome-side liner; and

FIG. 23 is an explanatory drawing schematically illustrating an example of sectional shapes of pipe forming portions according to another embodiment.

### DETAILED DESCRIPTION OF EMBODIMENTS

### First Embodiment

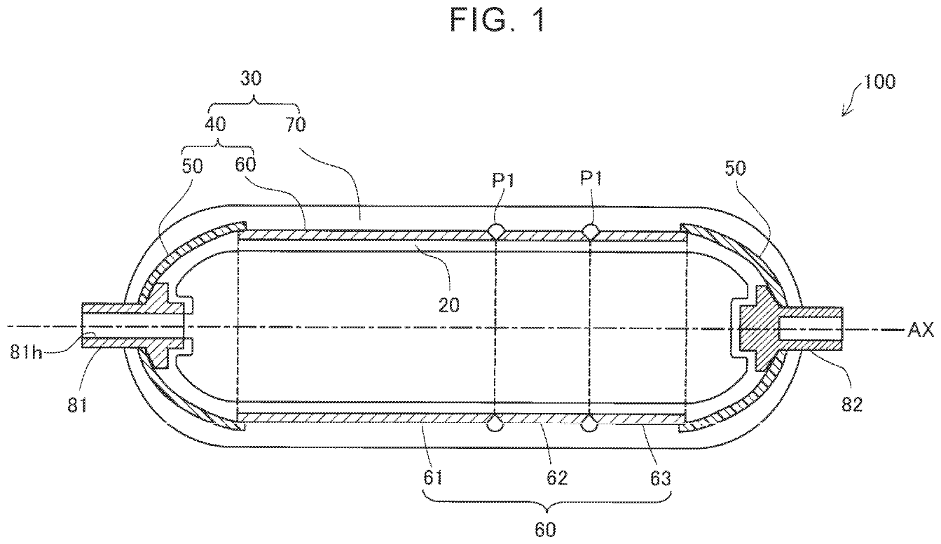

FIG. 1 is a sectional view illustrating the structure of a high-pressure tank 100 of a first embodiment. FIG. 1 illustrates a central axis AX of the high-pressure tank 100. The high-pressure tank 100 of this embodiment is a storage container that stores gas such as hydrogen gas. For example, the high-pressure tank 100 is used for storing hydrogen to be supplied to a fuel cell for a vehicle or a stationary fuel cell. For example, the high-pressure tank 100 stores a fluid having a high pressure of 10 to 70 MPa. The high-pressure tank 100 may store not only the hydrogen gas but also oxygen, natural gas, or the like.

The high-pressure tank 100 includes a reinforcing layer 30, a liner 20, a first cap 81, and a second cap 82. The liner 20 has a gas-barrier property, and is arranged on the inner surface of the reinforcing layer 30. The first cap 81 and the second cap 82 are arranged at opposite ends of the high-pressure tank 100. Axial directions of the individual portions agree with the central axis AX of the high-pressure tank 100. The first cap 81 has a communication hole 81h that communicates a space in the liner 20 with an external space. A connection device including a valve is arranged in the communication hole 81h. The second cap 82 has no communication hole that communicates with the external space, but may have the communication hole. The second cap 82 may be omitted.

The liner 20 is made of a resin having a gas-barrier property to suppress permeation of gas to the outside. Examples of the resin of the liner 20 include a mixed resin of high-density polyethylene and an ethylene-vinyl alcohol copolymer resin, and various resins having a gas-barrier property, such as nylon, polyamide, polypropylene, epoxy, and polyester.

The reinforcing layer 30 is a fiber-reinforced resin layer for reinforcing the liner 20, and includes a coupled body 40 and an outer helical layer 70. The coupled body 40 includes two reinforcing domes 50 and one reinforcing pipe 60. The resin of the reinforcing layer 30 may be a thermosetting resin such as a phenol resin, a melamine resin, a urea resin, or an epoxy resin, and is particularly preferably an epoxy resin from the viewpoint of mechanical strength or the like. For example, the fiber in the reinforcing layer 30 may be a glass fiber, an aramid fiber, a boron fiber, a carbon fiber, or a combination of the plurality of types of fiber. The fiber in the reinforcing layer 30 is preferably a carbon fiber from the viewpoint of lighter weight, mechanical strength, or the like.

The reinforcing dome 50 has a so-called semispherical shape with an outer diameter gradually increasing from a first end to a second end. The second end of the reinforcing dome 50 means an end closer to the center of the high-pressure tank 100 out of both ends of the reinforcing dome 50 along an axial direction of the high-pressure tank 100. The first cap 81 is arranged at the first end of the reinforcing dome 50. FIG. 1 illustrates the semispherical reinforcing dome 50, but the reinforcing dome 50 may have various shapes other than the semispherical shape, such as a flat-plate shape and a rectangular shape.

The reinforcing pipe 60 has a substantially cylindrical appearance shape. The reinforcing pipe 60 is formed by coupling a plurality of cylindrical pipe forming portions. In this embodiment, the reinforcing pipe 60 includes three pipe forming portions and junctions P1. The pipe forming portions are a first pipe forming portion 61, a second pipe forming portion 62, and a third pipe forming portion 63. In this embodiment, the first pipe forming portion 61, the second pipe forming portion 62, and the third pipe forming portion 63 are coupled by joining adjacent pipe forming portions by using the junctions P1.

The junction P1 is made of a resin-impregnated fiber, and has an appearance shape of a ring. For example, the fiber in the junction P1 may be a glass fiber, an aramid fiber, a boron fiber, or a carbon fiber, and is particularly preferably a carbon fiber from the viewpoint of lighter weight, mechanical strength, or the like. The resin of the junction P1 may be a thermoplastic resin such as polyamide, polypropylene, polyphenylene sulfide, polycarbonate, or thermoplastic polyurethane. The shape of the junction P1 may be not only the ring shape but also, for example, an arc shape or a flat-plate shape conforming to the outer peripheral shape of the reinforcing pipe 60. In a case where the junction P1 has the arc shape or the flat-plate shape, a plurality of junctions P1 is preferably arranged on outer peripheries of joining positions of the pipe forming portions 61, 62, and 63. The junction P1 can be formed by winding a fiber bundle around a substantially cylindrical mandrel similarly to a method for forming the first pipe forming portion 61, the second pipe forming portion 62, and the third pipe forcniny portion 63 as described later.

For example, the second pipe forming portion 62 and the third pipe forming portion 63 are used for extending the axial length of the reinforcing pipe 60. The lengths of the first pipe forming portion 61, the second pipe forming portion 62, and the third pipe forming portion 63 may be set arbitrarily. For example, the lengths of the first pipe forming portion 61, the second pipe forming portion 62, and the third pipe forming portion 63 may be equal to or different from each other. For example, in a case of manufacturing high-pressure tanks having a plurality of lengths, the length of the first pipe forming portion 61 is preferably set to a length corresponding to the length of a reinforcing pipe of a high-pressure tank having the shortest dimension among the high-pressure tanks having the plurality of lengths from the viewpoint of increasing manufacturing efficiency. The second pipe forming portion 62 and the third pipe forming portion 63 are preferably set to have lengths that compensate for a difference between the length of the first pipe forming portion 61 and the length of a reinforcing pipe of each of the high-pressure tanks having the plurality of lengths, that is, set to have lengths that extend the first pipe forming portion 61. As in the case of the second pipe forming portion 62 and the third pipe forming portion 63, the lengths of the pipe forming portions to be used for extending the first pipe forming portion 61 are preferably set equal to each other from the viewpoint of improving productivity.

The reinforcing dome 50 is arranged at each of both ends of the reinforcing pipe 60 so that the inner surfaces of the reinforcing domes 50 come into contact with the outer surface of the reinforcing pipe 60. The outer helical layer 70 is formed by helically winding a resin-impregnated fiber around the outer surface of the coupled body 40 including the reinforcing domes 50 and the reinforcing pipe 60. The outer helical layer 70 mainly functions to prevent detachment of the reinforcing dome 50 from the reinforcing pipe 60 when the internal pressure of the high-pressure tank 100 increases. For convenience of illustration in FIG. 1, hatching is omitted for the outer helical layer 70, the liner 20, and the junctions P1.

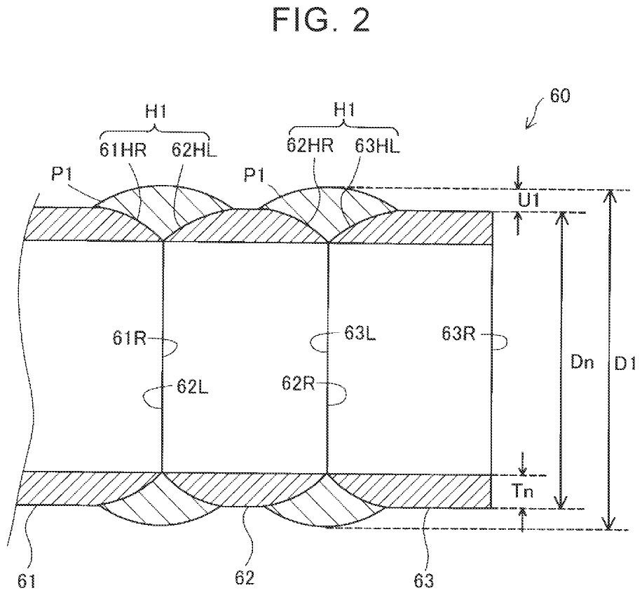

FIG. 2 is an explanatory drawing schematically illustrating the structure of the pipe forming portions. FIG. 2 illustrates an end 61R of the first pipe forming portion 61, a first end 62L and a second end 62R of the second pipe forming portion 62, and a first end 63L and a second 63R of the third pipe forming portion 63. The first pipe forming portion 61 is joined to the second pipe forming portion 62 by the junction P1 in a state in which the end 61R abuts against the first end 62L of the second pipe forming portion 62. The second pipe forming portion 62 is joined to the third pipe forming portion 63 by the junction P1 in a state in which the second end 62R of the second pipe forming portion 62 abuts against the first end 63L of the third pipe forming portion 63. The other end (not illustrated) of the first pipe forming portion 61 and the second end 63R of the third pipe forming portion 63 correspond to both the ends of the reinforcing pipe 60.

A diameter-decreasing portion 61HR is formed on an outer surface near the end 61R of the first pipe forming portion 61. The diameter-decreasing portion 61HR is a portion where the outer diameter of the reinforcing pipe 60 gradually decreases toward the end 61R by gradually reducing the thickness of the fiber-reinforced resin layer toward the end 61R. The inner diameters of the first pipe forming portion 61, the second pipe forming portion 62, and the third pipe forming portion 63 are substantially constant. The first end 62L of the second pipe forming portion 62 has a diameter-decreasing portion 62HL where the diameter decreases toward the first end 62L. The diameter-decreasing portion 61HR and the diameter-decreasing portion 62HL form a groove-shaped recess H1 on the outer surface of the reinforcing pipe 60 by causing the end 61R and the first end 62L to abut against each other. Similarly, a diameter-decreasing portion 62HR of the second end 62R of the second pipe forming portion 62 and a diameter-decreasing portion 63HL of the first end 63L of the third pipe forming portion 63 form a recess H1 on the outer surface of the reinforcing pipe 60. The junction P1 is arranged in each recess H1.

FIG. 2 illustrates an outer diameter Dn and a thickness Tn of the reinforcing pipe 60. The outer diameter Dn is equal to maximum diameters of the first pipe forming portion 61, the second pipe forming portion 62, and the third pipe forming portion 63. The thickness Tn means a maximum value of the thickness of the reinforcing pipe 60. As illustrated in FIG. 2, an outer diameter D1 of the junction P1 is larger than the outer diameter Dn of the reinforcing pipe 60. The junction P1 protrudes from the outer surface of the reinforcing pipe 60 toward an outer side of the reinforcing pipe 60 by an amount corresponding to a thickness U1. The maximum thickness of the junction P1 is larger than the thickness Tn.

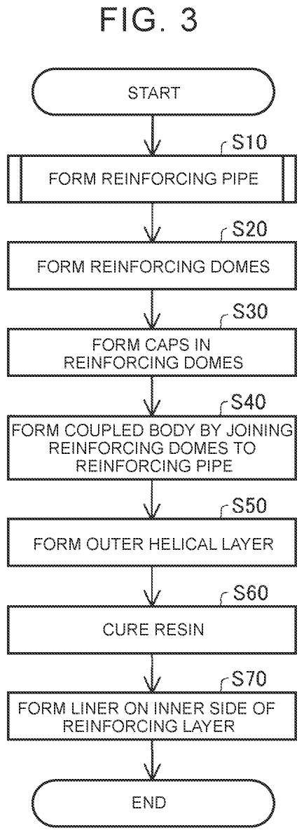

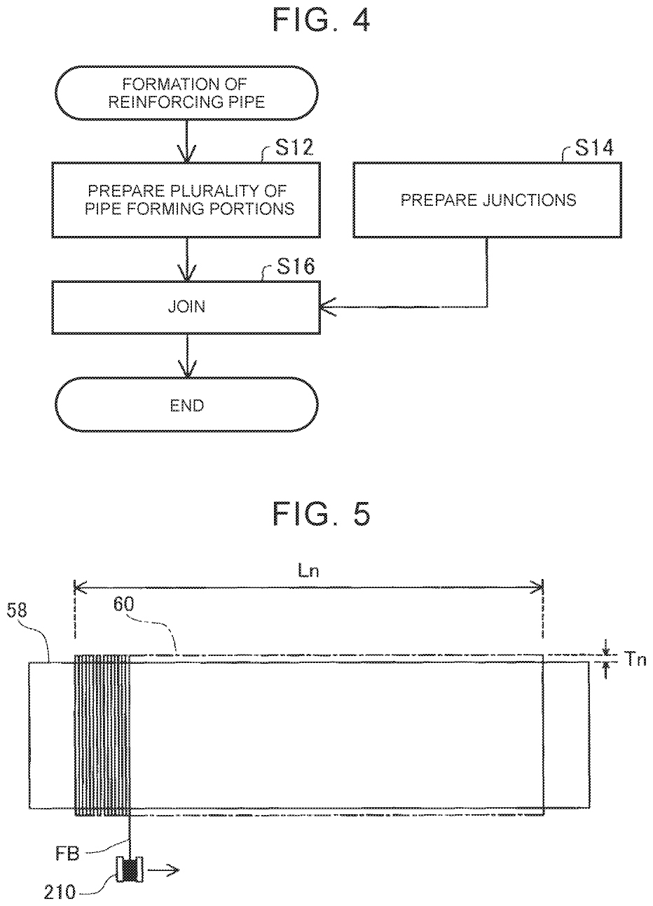

Next, a method for manufacturing the high-pressure tank 100 is described with reference to FIG. 3 to FIG. 8. FIG. 3 is a process drawing illustrating the method for manufacturing the high-pressure tank 100. FIG. 4 is a process drawing illustrating a method for manufacturing the reinforcing pipe 60. In Step S10, the reinforcing pipe 60 is formed. In Step S12 of FIG. 4, a plurality of pipe forming portions is prepared. That is, the first pipe forming portion 61, the second pipe forming portion 62, and the third pipe forming portion 63 are prepared.

FIG. 5 is an explanatory drawing illustrating an example of a method for forming the first pipe forming portion 61, the second pipe forming portion 62, and the third pipe forming portion 63. The first pipe forming portion 61, the second pipe forming portion 62, and the third pipe forming portion 63 can be formed by winding a fiber bundle FB around a substantially cylindrical mandrel 58 by a filament winding method. In the filament winding method, the fiber bundle FB is wound around the mandrel 58 by moving a fiber bundle guide 210 while rotating the mandrel 58. FIG. 5 illustrates an axial width Ln and a thickness Tn of the fiber bundle FB wound around the mandrel 58. The width Ln corresponds to the axial length of each of the first pipe forming portion 61, the second pipe forming portion 62, and the third pipe forming portion 63, and can arbitrarily be adjusted based on a movement amount of the fiber bundle guide 210. For example, the first pipe forming portion 61, the second pipe forming portion 62, and the third pipe forming portion 63 having different lengths can be formed by setting the width Ln to the length of each of the first pipe forming portion 61, the second pipe forming portion 62, and the third pipe forming portion 63. The thickness Tn can be set to an arbitrary thickness by, for example, adjusting a rotation speed of the mandrel 58, that is, the number of turns of the fiber bundle FB. For example, the diameter-decreasing portions 61HR, 62HL, 62HR, and 63HL can be formed by gradually reducing the number of turns in a moving direction of the fiber bundle guide 210. Pipe forming portions having different inner diameters and internal shapes can be formed by changing the shape of the outer surface of the mandrel 58, for example, by providing a projection or recess in the outer surface of the mandrel 58. One pipe forming portion may be formed by using one mandrel 58. Alternatively, a plurality of pipe forming portions may simultaneously be formed around one mandrel 58. For example, the second pipe forming portion 62 and the third pipe forming portion 63 may simultaneously be formed by using one mandrel 58. In the example of FIG. 5, the fiber bundle FB is wound by hooping the fiber bundle FB, but the fiber bundle FB may be wound helically. The filament winding (FW) method may be any one of the following wet FW and dry FW.

In general, the following methods exist as typical methods for forming an object from a fiber-reinforced resin.

Wet FW

Wet FW is a method that involves impregnating, immediately before winding the fiber bundle FB, a liquid resin having a low viscosity into the fiber bundle FB, and winding the resin-impregnated fiber bundle around the mandrel.

Dry FW

Dry FW is a method that involves preparing a tow-prepreg by drying a fiber bundle pre-impregnated with a resin, and winding the tow-prepreg around the mandrel.

Resin Transfer Molding (RTM)

RTM is a method that involves molding fibers by placing the fibers in a pair of male and female molds and injecting a resin through a resin inlet after fastening the molds to impregnate the resin into the fibers.

Centrifugal Winding (CW)

CW is a method that involves forming a tubular member by attaching a fiber sheet to the inner surface of a rotating cylindrical mold. The fiber sheet may be a fiber sheet pre-impregnated with a resin, or a fiber sheet that is not impregnated with the resin. In the latter case, the fiber sheet is wound into a tubular shape, and then the resin is injected into the mold and impregnated into the fiber sheet.

In the example of FIG. 5, the first pipe forming portion 61, the second pipe forming portion 62, and the third pipe forming portion 63 are formed by the filament winding method, but may be formed by another method such as RTM. The resin of each of the first pipe forming portion 61, the second pipe forming portion 62, and the third pipe forming portion 63 or the reinforcing pipe 60 may be cured in Step S10 or Step S60.

In Step S14 of FIG. 4, the junctions P1 are prepared. The junctions P1 may be prepared simultaneously with Step S12 or before or after Step S12. In this embodiment, two junctions P1 are prepared in Step S14. The number of junctions P1 to be prepared is at least equal to the number of joining points of the pipe forming portions. In Step S16, the first pipe forming portion 61, the second pipe forming portion 62, and the third pipe forming portion 63 are joined by using the prepared junctions P1.

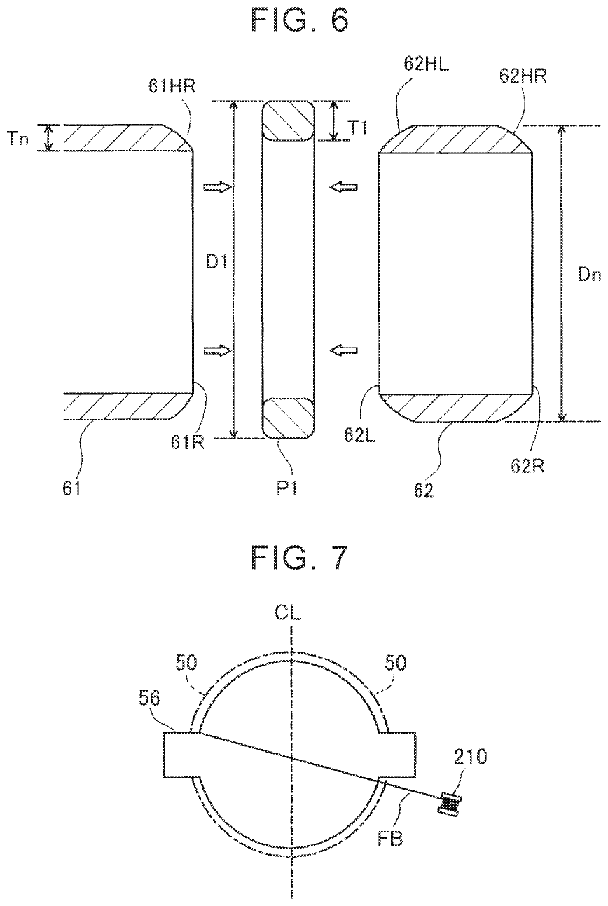

FIG. 6 is an explanatory drawing schematically illustrating a method for joining the first pipe forming portion 61 and the second pipe forming portion 62. A method for joining the second pipe forming portion 62 and the third pipe forming portion 63 is similar to the method for joining the first pipe forming portion 61 and the second pipe forming portion 62, and its description is therefore omitted. As illustrated in FIG. 6, the junction P1 has a thickness T1 larger than the thickness Tn of the reinforcing pipe 60, and has the outer diameter D1 larger than the outer diameter Dn of the reinforcing pipe 60. The inner diameter of the junction P1 is larger than the inner diameters of the first pipe forming portion 61 and the second pipe forming portion 62. The junction P1 is arranged between the end 61R of the first pipe forming portion 61 and the first end 62L of the second pipe forming portion 62.

When the first pipe forming portion 61 and the second pipe forming portion 62 are moved toward the junction P1, the recess H1 is formed by causing the end 61R and the first end 62L to abut against each other on the inner surface of the junction P1. The junction P1 is arranged in the formed recess H1. The junction P1 may be fitted into the recess H1 by inserting the end of any one of the first pipe forming portion 61 and the second pipe forming portion 62 abutting against each other into the junction P1. The junction P1 is thermocompressively bonded to the recess H1 by heating the junction P1 arranged in the recess H1 to a temperature equal to or higher than a melting point of the thermoplastic resin of the junction P1, such as 150° C. or 200° C. Thus, the first pipe forming portion 61 and the second pipe forming portion 62 are joined together. The reinforcing pipe 60 formed by joining the first pipe forming portion 61, the second pipe forming portion 62, and the third pipe forming portion 63 is heated to cure the resin. The thermocompression bonding of the junction P1 may be performed simultaneously with the curing of the resin of the reinforcing pipe 60.

In a case where the resin of the reinforcing pipe 60 is cured in Step S10, complete curing or precuring falling short of the complete curing may be performed. In the complete curing, the resin is completely cured until the viscosity of the resin is stable at a value equal to or larger than its target value. In general, when an uncured thermosetting resin is heated, the viscosity first decreases. When the resin is heated continuously, the viscosity increases. When the resin is heated continuously for a sufficient time, the viscosity of the resin is stable at a value equal to or larger than its target value. On the premise of this transition, “precuring” is a process in which curing is continued after the viscosity having decreased first and then increased again reaches the original viscosity and the curing is terminated at any time point before the end of the complete curing. When the precuring is performed in Step S10 and the complete curing is performed in Step S60 described later, the reinforcing pipe 60 can be joined more firmly to the reinforcing domes 50 and the outer helical layer 70.

In Step S20 of FIG. 3, the reinforcing domes 50 are formed. FIG. 7 is an explanatory drawing illustrating an example of a method for forming the reinforcing domes 50 in Step S20. The reinforcing domes 50 can be formed by winding the fiber bundle FB around a mandrel 56 by a filament winding method. The mandrel 56 preferably has an outer shape corresponding to a combination of two reinforcing domes 50. In the filament winding method, the fiber bundle FB is wound around the mandrel 56 by moving the fiber bundle guide 210 while rotating the mandrel 56. In the example of FIG, 7, the fiber bundle FB is wound helically. The filament winding method may be the wet FW or the dry FW described above. Two reinforcing domes 50 can be obtained by cutting the wound fiber bundle FB along a cutting line CL. The reinforcing domes 50 may be formed by another method such as RTM.

In Step S30 of FIG. 3, the first cap 81 or the second cap 82 is joined to each reinforcing dome 50. In Step S40, the coupled body 40 is formed by joining the reinforcing domes 50 to both the ends of the reinforcing pipe 60. For example, the joining in Step S30 and Step S40 can be performed by using an adhesive or a pressure-sensitive adhesive.

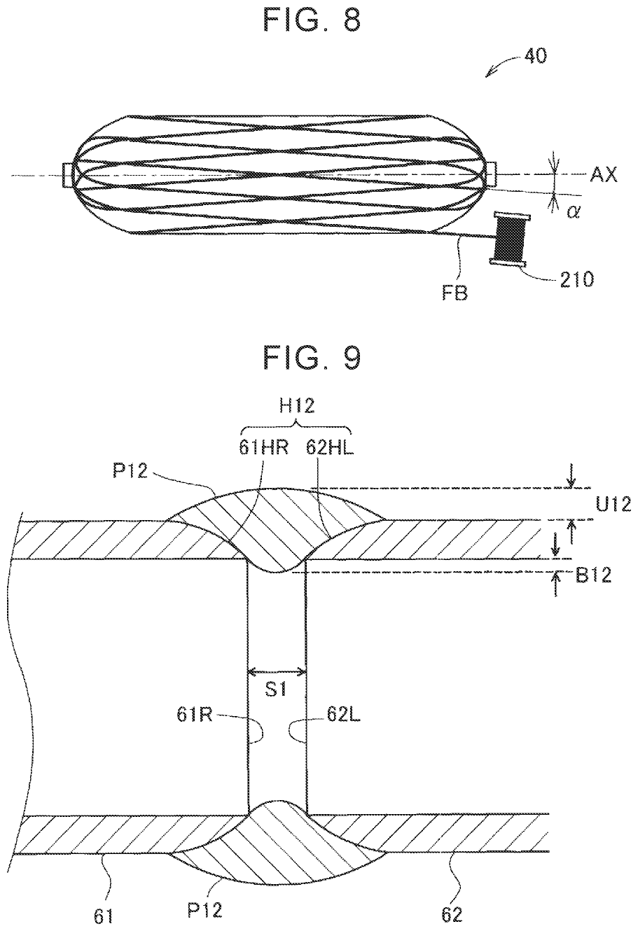

In Step S50 of FIG. 3, the outer helical layer 70 is formed around the outer surface of the coupled body 40. FIG. 8 is an explanatory drawing illustrating a method for forming the outer helical layer 70 in Step S50. The outer helical layer 70 can be formed by winding the fiber bundle FB around the outer surface of the coupled body 40 by a filament winding method. In the filament winding method, the fiber bundle FB is wound around the coupled body 40 by moving the fiber bundle guide 210 while rotating the coupled body 40 about the central axis AX. The filament winding method may be the wet FW or the dry FW. The outer helical layer 70 mainly functions to prevent detachment of the reinforcing dome 50 from the reinforcing pipe 60 when the internal pressure of the high-pressure tank 100 increases. To achieve this function, a winding angle α of the fiber bundle FB is preferably equal to or smaller than 45°. The winding angle α is an angle of the fiber bundle FB with respect to the central axis AX of the coupled body 40.

In Step S60 of FIG. 3, the uncured resin of the reinforcing layer 30 is cured. The curing corresponds to the complete curing described above. in Step S70, the liner 20 is formed on the inner surface of the cured reinforcing layer 30. In Step S70, the liner can be formed by, for example, injecting a liquid liner material into the reinforcing layer 30 with caps and curing the liner material while rotating the reinforcing layer 30. When the formation of the liner 20 is finished, the high-pressure tank 100 illustrated in FIG. 1 is completed. The liner 20 may be formed in a step other than Step S70 of FIG. 3. For example, the liner 20 may be formed separately from the reinforcing domes 50 and the reinforcing pipe 60, and then the liner 20, the two reinforcing domes 50, the first cap 81, and the second cap 82 may be joined in Step S30. The liner 20 can be formed in this manner by, for example, injection molding. In this case, the liner 20 may be formed in such a manner that two segments of the liner 20 to be obtained by splitting the entire liner 20 substantially at the center are separately subjected to injection molding and are joined after being ejected from an injection mold.

According to the high-pressure tank 100 of this embodiment described above, the reinforcing layer 30 includes the cylindrical reinforcing pipe 60 formed by coupling the cylindrical pipe forming portions 61, 62, and 63. The axial dimension of the reinforcing pipe 60 can arbitrarily be adjusted by combining and joining an arbitrary number of pipe forming portions 61, 62, and 63 having arbitrary lengths. Thus, the dimension of the high-pressure tank 100 can be changed by a simple method without providing a plurality of manufacturing lines for manufacturing reinforcing pipes 60 having different lengths.

The high-pressure tank 100 of this embodiment includes the junction P1 for joining the adjacent pipe forming portions 61 and 62. The junction P1 is arranged in the recess H1 thrilled by causing the diameter-decreasing portions 61HR and 62HL of the adjacent first and second pipe forming portions 61 and 62 to abut against each other. By joining the outer surfaces by the junction P1 at the abutment position of the pipe forming portions 61 and 62 where the strength is likely to decrease, a decrease in the strength of the reinforcing pipe 60 can be suppressed or prevented. By providing the recess at the arrangement position of the junction P1, the arrangement position of the junction P1 can easily be recognized from the appearance. Thus, the junction P1 can easily be arranged at the abutment position of the pipe forming portions 61 and 62.

According to the high-pressure tank 100 of this embodiment, the outer diameter D1 of the junction P1 is larger than the outer diameter Dn of the reinforcing pipe 60. By arranging the junction P1 to cover the outer surfaces at the joining position of the first pipe forming portion 61 and the second pipe forming portion 62 where the strength is likely to decrease, the decrease in the strength of the reinforcing pipe 60 can be suppressed or prevented more securely. The junction P1 protrudes from the outer surface of the reinforcing pipe 60 toward the outer side of the reinforcing pipe 60 by the amount corresponding to the thickness U1. By setting the thickness of the junction P1 to be larger than the thickness of the reinforcing pipe 60, the strength at the joining position of the first pipe forming portion 61 and the second pipe forming portion 62 can be improved.

According to the high-pressure tank 100 of this embodiment, the material containing the reinforcing fiber and the thermoplastic resin is used for the junction P1. Thus, the first pipe forming portion 61 and the second pipe forming portion 62 can easily be joined by thermocompression bonding. By containing the fiber bundle, the strength at the joining position of the first pipe forming portion 61 and the second pipe forming portion 62 can be improved.

According to the method for manufacturing the high-pressure tank 100 of this embodiment, the reinforcing pipe 60 is formed by joining the first pipe forming portion 61, the second pipe forming portion 62, and the third pipe forming portion 63 by the junctions P1, and then the liner 20 is formed on the inner surface of the formed reinforcing pipe 60. By forming the liner 20 after joining the first pipe forming portion 61, the second pipe forming portion 62, and the third pipe forming portion 63, it is possible to reduce or prevent such a trouble that the liner 20 enters the abutment positions of the first pipe forming portion 61, the second pipe forming portion 62, and the third pipe forming portion 63 when the high-pressure tank 100 is charged with gas, as compared to a case where the liners 20 are individually formed on the first pipe forming portion 61, the second pipe forming portion 62, and the third pipe forming portion 63 are then joined together.

Other Aspect 1 of First Embodiment

FIG. 9 is an explanatory drawing schematically illustrating the structure of pipe forming portions as Other Aspect 1 of the first embodiment. This embodiment differs from the first embodiment in that the end 61R of the first pipe forming portion 61 and the first end 62L of the second pipe forming portion 62 are joined while being spaced away from each other by a distance S1, and a junction P12 having a different shape is provided in place of the junction P1. This embodiment is similar to the first embodiment in terms of the other structure. As illustrated in FIG. 9, the junction P12 is arranged in a recess H12 formed by the diameter-decreasing portion 61HR and the diameter-decreasing portion 62HL, protrudes from the outer surface of the reinforcing pipe 60 toward the outer side of the reinforcing pipe 60 by an amount corresponding to a thickness U12, and further protrudes from the inner surface of the reinforcing pipe 60 toward an axis center of the reinforcing pipe 60 by an amount corresponding to a thickness B12.

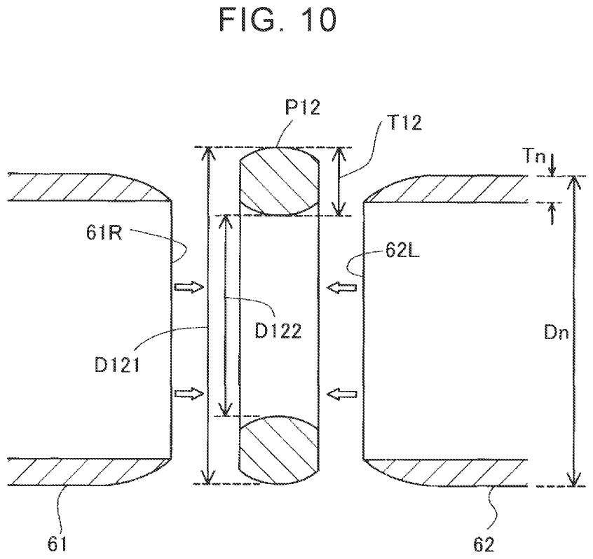

FIG. 10 is an explanatory drawing schematically illustrating a method for joining the first pipe forming portion 61 and the second pipe forming portion 62. The junction P12 has a thickness T12 larger than the thickness Tn of the reinforcing pipe 60, and has an outer diameter D121 larger than the outer diameter Dn of the reinforcing pipe 60. The thickness T12 is larger than the thickness T1 of the junction P1 of the first embodiment. An inner diameter D122 of the junction P12 means a minimum value of the inner diameter of the junction P12. The inner diameter D122 is smaller than the inner diameters of the first pipe forming portion 61 and the second pipe forming portion 62. The width of the junction P12 is larger than the distance S1. The distance S1 may be set to an arbitrary distance, but is preferably small to the extent that the strength of the reinforcing pipe 60 does not decrease.

When the first pipe forming portion 61 and the second pipe forming portion 62 are moved toward the junction P12, the recess H12 is formed by causing the end 61R of the first pipe forming portion and the first end 62L, of the second pipe forming portion to approach each other on the inner surface of the junction P12 to positions where the distance S1 is secured. Ihe junction P12 is arranged in the recess H12. The inner diameter D122 of the junction P12 is smaller than the inner diameters of the first pipe forming portion 61 and the second pipe forming portion 62. The inner surface of the junction P12 is pushed inward from a space between the end 61R of the first pipe forming portion and the first end 62L of the second pipe forming portion, and protrudes toward axis centers of the first pipe forming portion 61 and the second pipe forming portion 62 as illustrated in FIG. 9. The junction P12 is thermocompressively bonded to the recess H12 by heating. Thus, the first pipe forming portion 61 and the second pipe forming portion 62 are joined together.

According to the high-pressure tank 100 of this embodiment, the junction P12 is arranged in the recess H12 formed in a state in which the diameter-decreasing portions 61HR and 62HL of the adjacent first and second pipe forming portions 61 and 62 approach each other. The outer diameter D121 of the junction P12 is larger than the outer diameter Dn of the reinforcing pipe 60. The inner diameter D122 of the junction P12 is smaller than the inner diameter of the reinforcing pipe 60. By forming the junction P12 to cover the outer surface of the reinforcing pipe 60 and protrude from the inner surface of the reinforcing pipe 60 toward the axis center of the reinforcing pipe 60, the junction P12 having a larger thickness than the thicknesses Tn of the first pipe forming portion 61 and the second pipe forming portion 62 can be arranged at the joining position of the first pipe forming portion 61 and the second pipe forming portion 62 where the strength is likely to decrease. Thus, the decrease in the strength at the joining position of the first pipe forming portion 61 and the second pipe forming portion 62 can be suppressed or prevented more securely.

Other Aspect 2 of First Embodiment

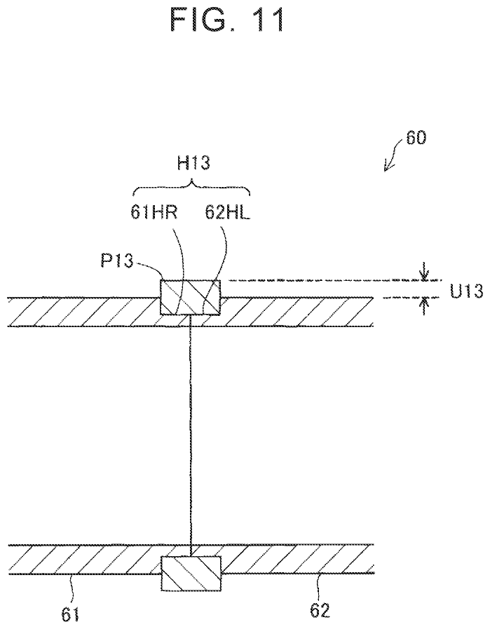

FIG. 11 is an explanatory drawing schematically illustrating the structure of pipe forming portions as Other Aspect 2 of the first embodiment. This embodiment differs from the first embodiment in that the shape of the diameter-decreasing portion 61HR of the first pipe forming portion 61 and the shape of the diameter-decreasing portion 62HL of the second pipe forming portion 62 are different, and a junction P13 having a different shape is provided in place of the junction P1. This embodiment is similar to the first embodiment in terms of the other structure. As illustrated in FIG. 11, the junction P13 is arranged in a substantially rectangular recess H13 formed by the diameter-decreasing portion 61HR and the diameter-decreasing portion 62HL, and protrudes from the outer surface of the reinforcing pipe 60 toward the outer side of the reinforcing pipe 60 by an amount corresponding to a thickness U13.

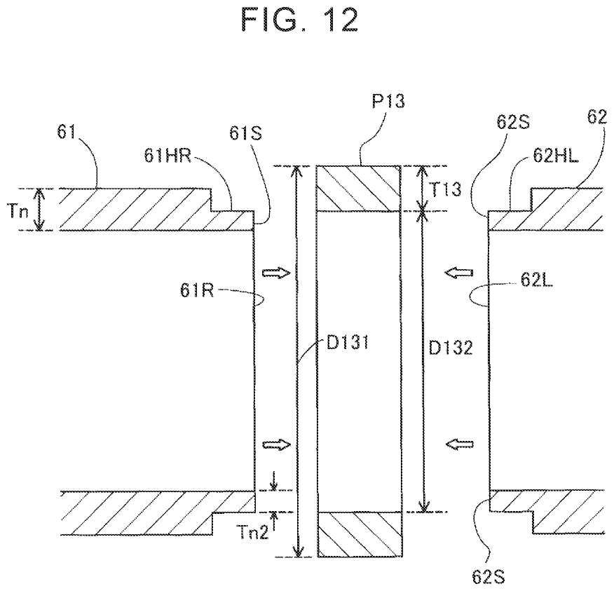

FIG. 12 is an explanatory drawing schematically illustrating a method for joining the first pipe forming portion 61 and the second pipe forming portion 62. The junction P13 has a substantially rectangular sectional shape, has a thickness T13 equal to the thickness Tn of the reinforcing pipe 60, and has an outer diameter D131 larger than the outer diameter Dn of the reinforcing pipe 60. An inner diameter D132 of the junction P13 corresponds to the outer diameter of the recess H13, that is, the outer diameters of the diameter-decreasing portion 61HR and the diameter-decreasing portion 62HL. The width of the junction P13 corresponds to the width of the recess H13.

The diameter-decreasing portion 61HR is formed into a rectangular shape by trimming an outer peripheral surface near the end 61R of the first pipe forming portion 61 having the thickness Tn so that the outer peripheral surface has, for example, a thickness Tn2 that is substantially a half of the thickness Tn of the first pipe forming portion 61. By forming the diameter-decreasing portion 61HR, an abutment surface 61S having the thickness Tn2 is formed near the end 61R. The thickness Tn2 is not limited to the substantial half of the thickness Tn of the first pipe forming portion 61, and may arbitrarily be adjusted depending on the thickness of the junction P13 or the required strength of the reinforcing pipe 60. The diameter-decreasing portion 62HL is provided near the first end 62L of the second pipe forming portion 62 so that the second pipe forming portion 62 is substantially line-symmetric to the first pipe forming portion 61 across the junction P13. The second pipe forming portion 62 has an abutment surface 62S that faces the abutment surface 61S. The abutment surface 61S and the abutment surface 62S are perpendicular to an axial direction of the reinforcing pipe 60. The abutment surface 61S and the abutment surface 62S may be formed by machining such as trimming, grinding, or cutting together with or independently of the diameter-decreasing portion 61HR and the diameter-decreasing portion 62HL. When the first pipe forming portion 61 and the second pipe forming portion 62 are moved toward the junction P13, the abutment surface 61S and the abutment surface 62S abut against each other on the inner surface of the junction P13. The junction P13 is arranged on the outer surface of the recess H13 formed by causing the diameter-decreasing portion 61HR and the diameter-decreasing portion 62HL to abut against each other.

According to the high-pressure tank 100 of this embodiment, the end 61R of the first pipe forming portion 61 has the abutment surface 61S, and the first end 62L of the second pipe forming portion 62 has the abutment surface 62S that abuts against the abutment surface 61S. By bringing the first pipe forming portion 61 and the second pipe forming portion 62 into surface contact with each other at their joining position, axial displacement is reduced or prevented. Thus, variation in the axial dimension of the reinforcing pipe 60 can be reduced.

### Second Embodiment

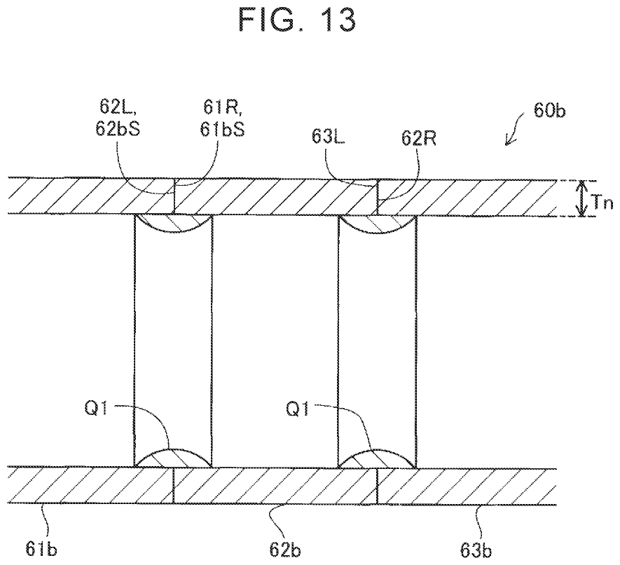

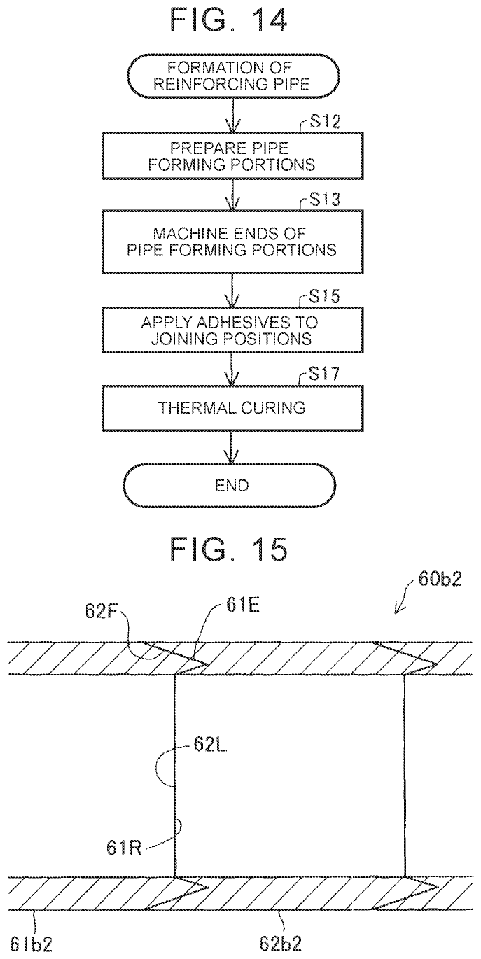

The structure of a high-pressure tank 100 of a second embodiment is described with reference to FIG. 13 and FIG. 14. FIG. 13 is an explanatory drawing schematically illustrating the structure of pipe forming portions according to the second embodiment. The high-pressure tank 100 of the second embodiment differs from the high-pressure tank 100 of the first embodiment in that a reinforcing pipe 60b is provided in place of the reinforcing pipe 60 and the junctions P1 are not provided. The reinforcing pipe 60b differs from the reinforcing pipe 60 of the first embodiment in that the recesses are not provided. The other structure of the high-pressure tank 100 of the second embodiment is similar to that of the first embodiment.

The reinforcing pipe 60b includes a first pipe forming portion 61b, a second pipe forming portion 62b, and a third pipe forming portion 63b. An end 61R of the first pipe forming portion 61b has an abutment surface 61bS (first abutment surface). A first end 62L of the second pipe forming portion 62b has an abutment surface 62bS (second abutment surface), A second end 62R of the second pipe forming portion 62b and a first end 63L of the third pipe forming portion 63b also have similar abutment surfaces. The abutment surfaces 61bS and 62bS are perpendicular to an axial direction of the reinforcing pipe 60b. The thicknesses of the abutment surfaces 61bS and 62bS are equal to thicknesses Tn of the first pipe forming portion 61b and the second pipe forming portion 62b, and are larger than, for example, the thickness Tn2 of the abutment surface 61S illustrated in FIG. 12. In a state in which the reinforcing pipe 60b is formed as illustrated in FIG. 13, the abutment surface 61bS of the first pipe forming portion 61b and the abutment surface 62bS of the second pipe forming portion 62b abut against each other.

In this embodiment, the first pipe forming portion 61b, the second pipe forming portion 62b, and the third pipe forming portion 63b are joined by using adhesives Q1. A pressure-sensitive adhesive may be used in place of the adhesive Q1. The adhesives Q1 are applied to cover inner peripheral surfaces at the joining positions of the first pipe forming portion 61b, the second pipe forming portion 62b, and the third pipe forming portion 63b. The adhesive Q1 may be a thermosetting resin such as a phenol resin, a melamine resin, a urea resin, or an epoxy resin, and is particularly preferably an epoxy resin from the viewpoint of mechanical strength or the like. The adhesive Q1 may further contain a reinforcing fiber such as a glass fiber, an aramid fiber, a boron fiber, or a carbon fiber from the viewpoint of improving the strength of the reinforcing pipe 60b.

FIG. 14 is a process drawing illustrating a method for manufacturing the reinforcing pipe 60b according to the second embodiment. In Step S12, the first pipe forming portion 61b, the second pipe forming portion 62b, and the third pipe forming portion 63b are formed by winding the fiber bundle FB around the substantially cylindrical mandrel 58 by the filament winding method similarly to the first embodiment, In Step S13, the first pipe forming portion 61b, the second pipe forming portion 62b, and the third pipe forming portion 63b having the abutment surfaces 61bS and 62bS are formed by a method such as grinding, trimming, or cutting of the ends of the formed first pipe forming portion 61b, the formed second pipe forming portion 62b, and the formed third pipe forming portion 63b along planes perpendicular to the axial direction. In a case where the abutment surfaces 61bS and 62bS can be formed in Step S12, Step S13 may be omitted. In Step S15, the abutment surfaces of adjacent pipe forming portions, such as the abutment surface 61bS and the abutment surface 62bS, are fixed while abutting against each other, and the adhesives Q1 are applied to the abutment positions from an inner side of the first pipe forming portion 61b, the second pipe forming portion 62b, and the third pipe forming portion 63b. To improve the strength of the reinforcing pipe 60b, the adhesives Q1 may be applied to the abutment surfaces of the first pipe forming portion 61b, the second pipe forming portion 62b, and the third pipe forming portion 63b or the outer peripheral surfaces of the first pipe forming portion 61b, the second pipe forming portion 62b, and the third pipe forming portion 63b together with or in place of the inner peripheral surfaces of the first pipe forming portion 61b, the second pipe forming portion 62b, and the third pipe forming portion 63b. In Step S17, the adhesives Q1 are thermally cured. Step S17 may be omitted and the adhesives Q1 may thermally be cured simultaneously with the complete curing or precuring of the reinforcing pipe 60b. In a case where precuring is performed in Step S17, the adhesives Q1 may be cured simultaneously with the complete curing of the reinforcing layer 30 in Step S60.

According to the high-pressure tank 100 of this embodiment, the end 61R of the first pipe forming portion 61b and the first end 62L of the second pipe forming portion 62b have the abutment surfaces 61bS and 62bS that are substantially perpendicular to the axial direction and have thicknesses equal to the thicknesses Tn of the first pipe forming portion 61b and the second pipe forming portion 62b. By increasing the contact area between the pipe forming portions 61b and 62b at their joining position, axial displacement is reduced or prevented at the joining position. Thus, variation in the axial dimension of the reinforcing pipe 60b can be reduced.

According to the high-pressure tank 100 of this embodiment, the abutment surfaces 61bS and 62bS are formed by cutting the ends 61R and 62L of the pipe forming portions 61b and 62b along the planes perpendicular to the axial direction. As compared to a case where the abutment surfaces 61bS and 62bS are formed by the filament winding method alone, the surface roughnesses of the abutment surfaces 61bS and 62bS can be reduced, and the axial displacement can be reduced or prevented at the joining position, Thus, the variation in the axial dimension of the reinforcing pipe 606 can be reduced.

### Other Aspect of Second Embodiment

FIG. 15 is an explanatory drawing schematically illustrating the structure of pipe forming portions as another aspect of the second embodiment. A high-pressure tank 100 of this embodiment differs from the high-pressure tank 100 of the first embodiment in that a reinforcing pipe 60b2 is provided and the junctions P1 are not provided. The reinforcing pipe 60b2 differs from the reinforcing pipe 60 of the first embodiment in that a fitting portion 61E and a fitted portion 62F are provided in place of the recess H1. The other structure of the high-pressure tank 100 is similar to that of the first embodiment.

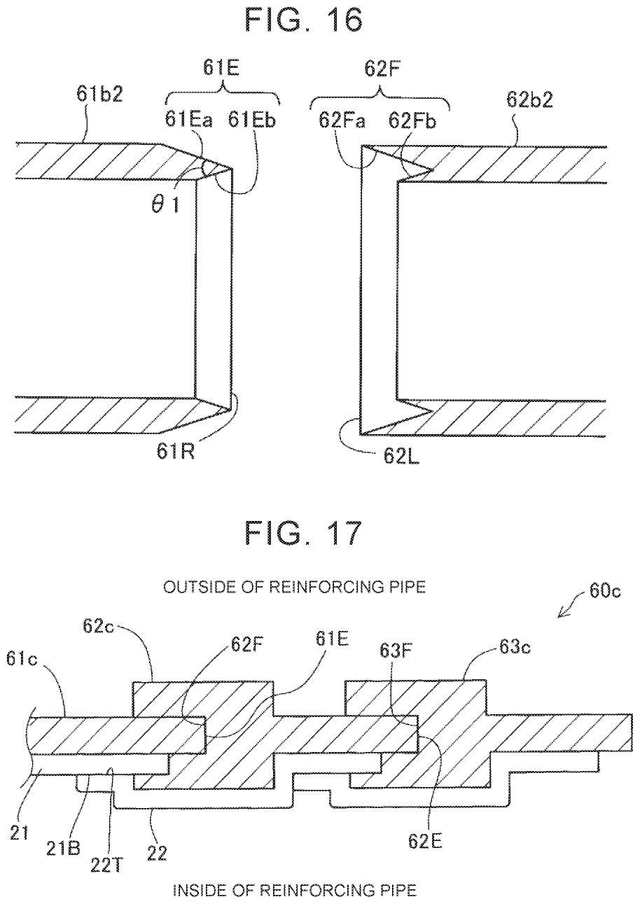

FIG. 16 is an explanatory drawing illustrating an end 61R of a first pipe forming portion 61b2 and a first end 62L of a second pipe forming portion 62b2. In the reinforcing pipe 60b2, the end 61R of the first pipe forming portion 61b2 and the first end 62L of the second pipe forming portion 62b2 have abutment surfaces 61E and 62F having sectional shapes different from those of the abutment surface 61bS and the abutment surface 62bS of the second embodiment. The abutment surface 61E is shaped to protrude toward the second pipe forming portion 62b2, and is formed by, for example, cutting, trimming, or grinding the end 61R of the first pipe forming portion 61b2 in Step S13 of FIG. 14. The abutment surface 61E includes an outer peripheral surface 61Ea and an inner peripheral surface 61Eb, and is shaped to protrude toward the second pipe forming portion 62b2 by forming an inferior angle as an angle θ1 between the outer peripheral surface 61Ea and the inner peripheral surface 61Eb. The abutment surface 61E functions as the fitting portion 61E to be fitted to the fitted portion of the adjacent second pipe forming portion 62b2.

The abutment surface 62F has a recessed shape conforming to the projecting shape of the abutment surface 61E, and is formed by cutting or trimming the first end 62L of the second pipe forming portion 62b2. The abutment surface 62F includes a first surface 62Fa and a second surface 62Fb. The first surface 62Fa abuts against the outer peripheral surface 61Ea of the first pipe forming portion 61b2. The second surface 62Fb abuts against the inner peripheral surface 61Eb of the first pipe forming portion 61b2. The abutment surface 62F functions as the fitted portion 62F to which the fitting portion 61E of the first pipe forming portion 61b2 is fitted. In this embodiment, the areas of the outer peripheral surface 61Ea and the first surface 62Fa are set larger than the areas of the inner peripheral surface 61Eb and the second surface 62Fb. This structure improves the strength on an outer side of the fitting position between the first pipe forming portion 61b2 and the second pipe forming portion 62b2. The first end 62L of the second pipe forming portion 62b2 may have the projecting fitting portion that protrudes toward the first pipe forming portion 61b2, and the end 61R of the first pipe forming portion 61b2 may have the fitted portion.

The fitting portion 61E is fitted to the fitted portion 62F by moving the first pipe forming portion 61b2 toward the second pipe forming portion 62b2 while their central axes AX agree with each other. The first pipe forming portion 61b2 and the second pipe forming portion 62b2 that are fitted together may be bonded thermocompressively by the complete curing or precuring of the reinforcing pipe 60b, or may be bonded by the thermal curing in Step S17 of FIG. 14 by applying the adhesive Q1 similar to that of the second embodiment or a pressure-sensitive adhesive to the fitting position. In a case where the adhesive Q1 is applied, the adhesive Q1 may be applied not only to the inner peripheral surface or the outer peripheral surface at the fitting position, but also to the abutment surface 62F or the abutment surface 61E.

According to the high-pressure tank 100 of this embodiment, the first pipe forming portion 61b2 has the fitting portion 61E to be fitted to the fitted portion 62F of the second pipe forming portion 62b2. Therefore, axial displacement is reduced or prevented at the joining position while improving the strength of the reinforcing pipe 60b2. Thus, variation in the axial dimension of the reinforcing pipe 60b2 can be reduced.

### Third Embodiment

The structure of a high-pressure tank 100 of a third embodiment is described with reference to FIG. 17 to FIG. 22. FIG. 17 is an explanatory drawing schematically illustrating the structure of pipe forming portions according to the third embodiment. The high-pressure tank 100 of the third embodiment differs from the high-pressure tank 100 of the first embodiment in that a reinforcing pipe 60c is provided in place of the reinforcing pipe 60 and the junctions P1 are not provided. The reinforcing pipe 60c is formed by joining a first pipe forming portion 61c, a second pipe forming portion 62c, and a third pipe forming portion 63c by thermocompression bonding of the liners 20. The other structure of the high-pressure tank 100 of the third embodiment is similar to that of the first embodiment.

As illustrated in FIG. 17, the reinforcing pipe 60c includes the first pipe forming portion 61c, the second pipe forming portion 62c, and the third pipe forming portion 63c. FIG. 17 schematically illustrates the sectional structure of a part of the reinforcing pipe 60c to facilitate understanding of the technology. As illustrated in FIG. 17, the first pipe forming portion 61c includes a fitting portion 61E to be fitted to a fitted portion 62F of the adjacent second pipe forming portion 62c. The second pipe forming portion 62c includes a fitting portion 62E to be fitted to a fitted portion 63F of the adjacent third pipe forming portion 63c. The first pipe forming portion 61c, the second pipe forming portion 62c, and the third pipe forming portion 63c are coupled by fitting the fitting portions 61E and 62E to the fitted portions 62F and 63F, respectively. The first pipe forming portion 61c, the second pipe forming portion 62c, and the third pipe forming portion 63c that are coupled together are joined by thermocompression bonding of abutment surfaces of the liners 20.

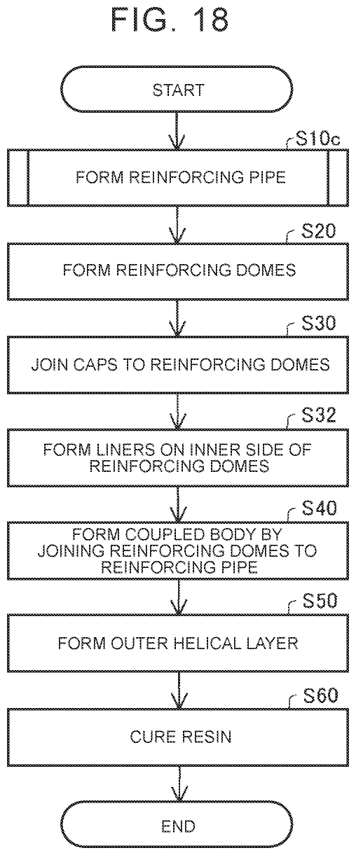

FIG. 18 is a process drawing illustrating a method for manufacturing the high-pressure tank 100 of the third embodiment. The method for manufacturing the high-pressure tank 100 of this embodiment differs from the method for manufacturing the high-pressure tank 100 of the first embodiment in that. Step S10c for forming the reinforcing pipe 60c is provided in place of Step S10, Step S32 is provided, and Step S70 is not provided.

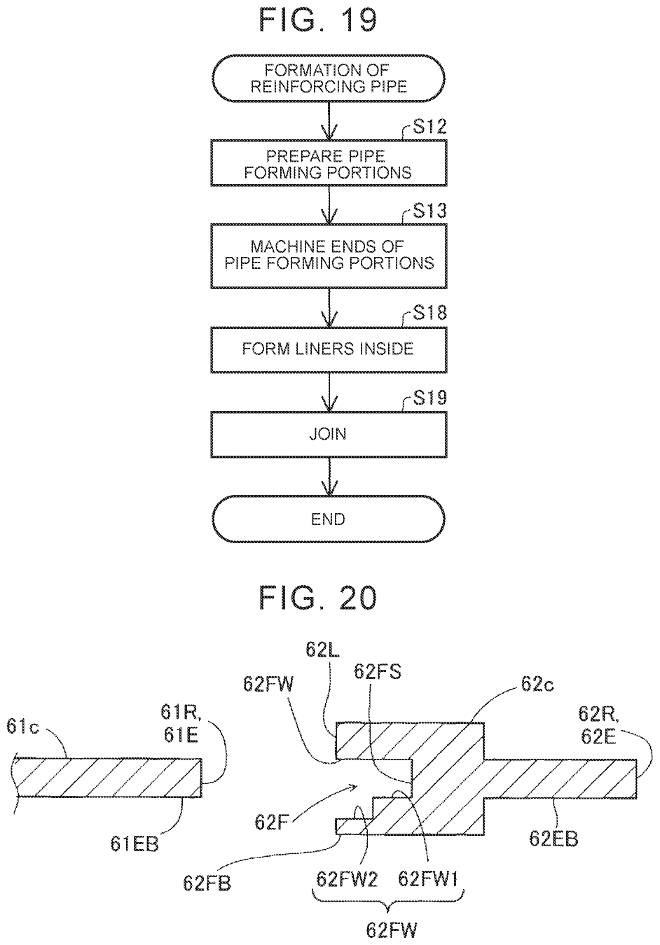

FIG. 19 is a process drawing illustrating the step of forming the reinforcing pipe 60c in Step S10c. In Step S12, the first pipe forming portion 61c, the second pipe forming portion 62c, and the third pipe forming portion 63c are formed by the filament winding method similarly to the first embodiment. In the following description, the method for manufacturing the third pipe forming portion 63c is similar to the method for manufacturing the second pipe forming portion 62c, and its description is therefore omitted.

FIG. 20 is an explanatory drawing illustrating the first pipe forming portion 61c and the second pipe forming portion 62c manufactured in Step S12. In Step S13, the first pipe forming portion 61c having the projecting fitting portion 61E that protrudes toward the second pipe forming portion 62c and the second pipe forming portion 62c having the recessed fitted portion 62F conforming to the shape of the fitting portion 61E and the fitting portion 62E that protrudes toward the third pipe forming portion 63c are formed by trimming or grinding an end 61R of the first pipe forming portion 61c prepared in Step S12 and a first end 62L of the second pipe forming portion 62c prepared in Step S12. The inner surface of the second pipe forming portion 62c includes an inner surface 62FB near the first end 62L and an inner surface 62EB near a second end 62R. The inner diameter of the inner surface 62FB is set smaller than the inner diameter of the inner surface 62EB. With this structure, the inner surface of the second pipe forming portion 62c has a step between the inner surface 62FB and the inner surface 62EB. The step to be formed by the difference between the inner diameter of the inner surface 62FB at the first end 62L of the second pipe forming portion 62c and the inner diameter of the inner surface 62EB at the second end 62R of the second pipe forming portion 62c can be formed by using a mandrel 58 having a stepped shape conforming to the shapes of the inner surface 62FB and the inner surface 62EB when forming the second pipe forming portion 62c in Step S12.

The fitted portion 62F of the second pipe forming portion 62c has a bottom face 62FS and side walls 62FW. The bottom face 62FS abuts against the fitting portion 61E of the first pipe forming portion 61c. The side walls 62FW surround the bottom face 62FS. The side wall 62FW on the inner side of the reinforcing pipe 60c includes a first side wall 62FW1 and a second side wail 62FW2 to have a step. The first side wall 62FW1 abuts against an inner surface 61EB of the fitting portion 61E. The second side wall 62FW2 is located at a position closer to the inner surface of the reinforcing pipe 60c than is the first side wall 62FW1. With this structure, the side wall 62FW of the fitted portion 62F has the step between the first side wall 62FW1 and the second side wall 62FW2. The height of the step between the first side wall 62FW1 and the second side wall 62FW2 corresponds to the height of a step between the inner surface 61EB of the fitting portion 61E and an inner surface 21B of a first liner 21.

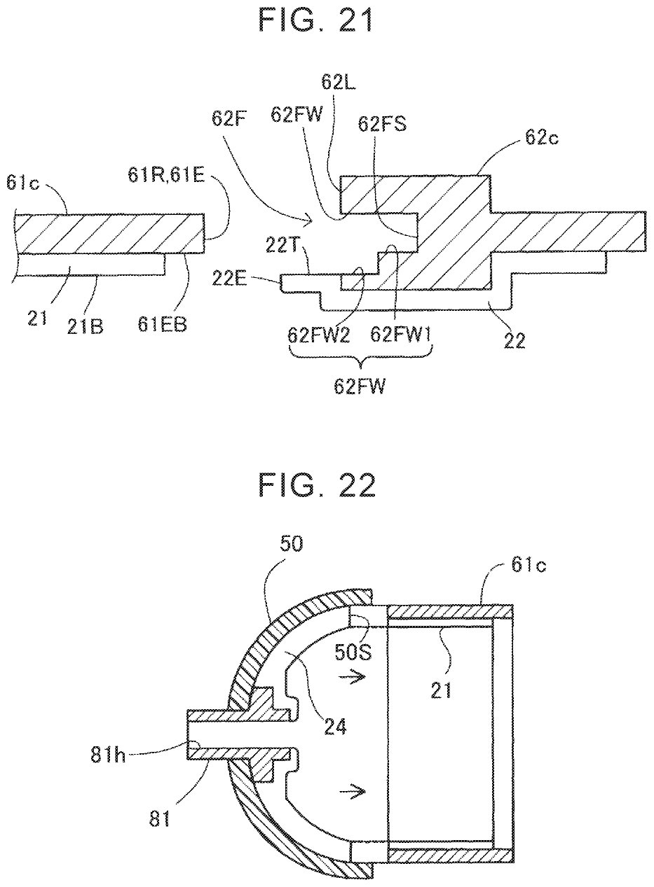

FIG. 21 is an explanatory drawing illustrating the first pipe forming portion 61c and the second pipe forming portion 62c on which the liners 20 are formed. In Step S18 of FIG. 19, the liners 20 are individually formed on the inner peripheral surfaces of the first pipe forming portion 61c and the second pipe forming portion 62c. More specifically, the first liner 21 is formed by applying a liquid liner material to the inner peripheral surface of the formed first pipe forming portion 61c, and a second liner 22 is formed by applying the liquid liner material to the inner peripheral surface of the second pipe forming portion 62c.

In regions where the liners 20 are formed on the inner peripheral surfaces of the first pipe forming portion 61c and the second pipe forming portion 62c, non-coated regions can be formed by covering, for example, regions other than coated regions with masking tapes when applying the liner material. As illustrated in FIG. 21, in this embodiment, a non-coated region of the first liner 21 is formed near the fitting portion 61E of the first pipe forming portion 61c by covering the inner surface 61EB near the fitting portion 61E. Thus, the shape near the fitting portion 61E of the first pipe forming portion 61c having the first liner 21 is a sectional shape having the step conforming to the first side tail 62FW1 and the second side wall 62FW2 of the fitted portion 62F. This structure increases the abutment area between the first liner 21 and the second pipe forming portion 62c to improve the joining strength of the first pipe forming portion 61c and the second pipe forming portion 62c. Thus, the strength of the reinforcing pipe 60c can be improved. For example, when applying the liner, an extension member (not illustrated) is temporarily attached to the pipe forming portion 62c to form a liner protrusion 22E of FIG. 21. As in this example, the regions where the liners 20 are formed can be extended from outer edges of the first pipe forming portion 61c and the second pipe forming portion 62c. An outer surface 22T of the liner protrusion 22E abuts against the inner surface 21B of the first liner 21. With the liner protrusion 22E of the second pipe forming portion 62c, the contact area between the first liner 21 and the second liner 22 increases to improve the joining strength of the first pipe forming portion 61c and the second pipe forming portion 62c. Thus, the strength of the reinforcing pipe 60c can be improved.

In Step S19 of FIG. 19, the first pipe forming portion 61c and the second pipe forming portion 62c are joined together. More specifically, the first pipe forming portion 61c and the second pipe forming portion 62c are coupled by fitting together the fitting portion 61E of the first pipe forming portion 61c having the first liner 21 and the fitted portion 62F of the second pipe forming portion 62c having the second liner 22, and are joined by thermocompressively bonding the first liner 21 and the second liner 22 by heating.

In Step S20 and Step S30 of FIG. 18, the reinforcing domes 50 are formed, and the first cap 81 is joined to one of the formed reinforcing domes 50. In Step S32 of this embodiment, dome-side liners 24 are formed on the inner surfaces of the reinforcing domes 50. More specifically, the dome-side liners 24 are formed by applying a liquid liner material to the inner surfaces of the formed reinforcing domes 50.

FIG. 22 is an explanatory drawing illustrating a method for joining the reinforcing pipe 60c to the reinforcing dome 50 having the dome-side liner 24. In this embodiment, as illustrated in FIG. 22, a recess 50S conforming to the shape of the end of the first pipe forming portion 61c is formed by providing a non-forming region with a masking tape or the like near the other end of the reinforcing dome 50 when forming the dome-side liner 24 in Step S32. When forming the coupled body 40 by joining the reinforcing dome 50 and the reinforcing pipe 60c, the end of the first pipe forming portion 61c of the reinforcing pipe 60c is joined to the recess 50S. In Step S50 of FIG. 18, the outer helical layer 70 is formed around the outer surface of the coupled body 40 similarly to the first embodiment. In Step S60, the uncured resin of the reinforcing layer 30 is cured completely. When the complete curing of the reinforcing layer 30 is finished, the high-pressure tank 100 of this embodiment is completed.

According to the method for manufacturing the high-pressure tank 100 of this embodiment, the first liner 21 and the second liner 22 are formed on the inner surface of the first pipe forming portion 61c and the inner surface of the second pipe forming portion 62c, respectively. The first pipe forming portion 61c and the second pipe forming portion 62c are joined by thermocompressiyely bonding the first liner 21 and the second liner 22 by heating in a state in which the fitting portion 61E of the first pipe forming portion 61c and the fitted portion 62F of the second pipe forming portion 62c are fitted together. Thus, the reinforcing pipe 60c is formed. The first pipe forming portion 61c and the second pipe forming portion 62c can be joined without using the adhesive or junction, and therefore the number of components can be reduced. By omitting the step of applying the adhesive or junction, the productivity of the reinforcing pipe 60c can be increased.

### Other Embodiments

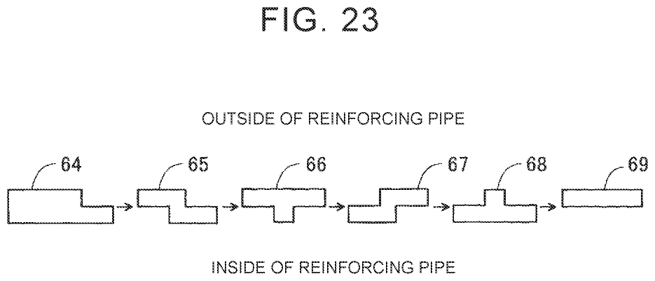

FIG. 23 is an explanatory drawing schematically illustrating an example of sectional shapes of pipe forming portions according to another embodiment. As demonstrated by pipe forming portions 64 to 69 of FIG. 23, various shapes may be employed as the sectional shapes of the pipe forming portions. To obtain the strength of the high-pressure tank 100, the ends of the pipe forming portions are preferably shaped to increase the area of the abutment surfaces of the pipe forming portions.

The embodiments described above are directed to the example in which the reinforcing pipe has three pipe forming portions. The number of pipe forming portions is not limited to three, and may be an arbitrary number such as two, four, or more.

The embodiments described above are directed to the example in which the recess H1, H12, or H13 is formed on the outer surface of the reinforcing pipe by causing adjacent pipe forming portions to abut against or approach each other. The recess may be formed on the inner surface of the reinforcing pipe. In this case, the junction may be arranged in the recess on the inner surface of the reinforcing pipe to join the adjacent pipe forming portions.

The present disclosure is not limited to the embodiments described above, but may be implemented by various structures without departing from the spirit of the present disclosure. For example, the technical features of the embodiments corresponding to the technical features of the individual aspects described in the “SUMMARY” section may be replaced or combined as appropriate to solve a part or all of the problems described above or attain a part or all of the effects described above. Any technical feature may be omitted as appropriate unless otherwise described as being essential herein.

1-9. (canceled)

10. A method for manufacturing a high-pressure tank, the method comprising:
causing adjacent cylindrical pipe forming portions to abut against each other;
arranging a junction made of a material containing a reinforcing fiber and a thermoplastic resin on an outer surface at an abutment position of the adjacent pipe forming portions;
forming a cylindrical reinforcing pipe by heating and thermocompressively bonding the junction to join the pipe forming portions; and
forming a liner made of a resin and having a gas-barrier property on an inner surface of the formed reinforcing pipe.

11. (canceled)

12. The high-pressure tank according to claim 10, wherein the junction is arranged in a recess provided between the adjacent pipe forming portions, the junction joining the adjacent pipe forming portions.

13. The high-pressure tank according to claim 10, wherein an outer diameter of the junction is larger than an outer diameter of the reinforcing pipe.

14. The high-pressure tank according to claim 10, wherein an inner diameter of the junction is smaller than an inner diameter of the reinforcing pipe.

15. The high-pressure tank according to claim 10, wherein a material for the junction contains a reinforcing fiber and a thermoplastic resin.

16. The high-pressure tank according to claim 10, wherein the junction protrudes from an outer surface of the reinforcing pipe toward an outer side of the reinforcing pipe.

17. The high-pressure tank according to claim 10, wherein the junction protrudes from an inner surface of the reinforcing pipe toward an axis center of the reinforcing pipe.
